(19) United States
(12) Patent Application Publication
(10) Pub. No.: US 2022/0134670 A1
(43) Pub. Date: May 5, 2022

(54) ADDITIVE MANUFACTURING LASER HEATING AND TEMPERATURE MONITORING SYSTEM AND METHOD

(71) Applicant: Evolve Additive Solutions, Inc., Minnetonka, MN (US)

(72) Inventor: John Samuel Batchelder, Somers, NY (US)

(21) Appl. No.: 17/432,730

(22) PCT Filed: Feb. 21, 2020
(86) PCT No.: PCT/US2020/019268

§ 371 Date: Aug. 20, 2021

Related U.S. Application Data
(60) Provisional application No. 62/808,722, filed on Feb. 21, 2019.

(51) Int. Cl. B29C 64/386; B33Y 30/00; B33Y 50/00; B29C 64/268; B29C 64/282; G03G 15/22; G03G 15/20

(52) U.S. Cl. CPC B29C 64/386; B33Y 30/00; B33Y 50/00; G03G 2215/1676; B29C 64/282; G03G 15/224; G03G 15/2007; B29C 64/268

(57) ABSTRACT

An apparatus for use in a selective toner electrophotographic process (STEP) additive manufacturing system, the apparatus includes a radiant heat source configured to emit radiation of a first band of wavelengths in the region of a transfuse roller nip; and a pyrometer configured to receive and measure radiation emitted from the region of the transfuse roller nip; wherein the radiation measured by the pyrometer comprises a second band of wavelengths different from the first band of wavelengths emitted by the radiant heat source. The radiant heat source is typically one or more laser light emitters.

This application is being filed as a PCT International Patent application on Feb. 21, 2020 in the name of Evolve Additive Solutions, Inc., a U.S. national corporation, applicant for the designation of all countries, and John Samuel Batchelder, a U.S. Citizen, inventor for the designation of all countries, and claims priority to U.S. Provisional Patent Application No. 62/808,722 filed Feb. 21, 2019, the contents of which are herein incorporated by reference in its entirety.

### FIELD

Embodiments herein relate to systems and methods for heating system components and monitoring the temperature of three-dimensional printing processes.

### BACKGROUND

The present disclosure relates to additive manufacturing systems for building three-dimensional (3D) parts and support structures. In particular, the present disclosure relates to additive manufacturing systems and processes for building 3D parts and support structures using an imaging process, such as electrophotography.

Additive manufacturing systems are used to build 3D parts from digital representations of the 3D parts using one or more additive manufacturing techniques. Examples of commercially available additive manufacturing techniques include extrusion-based techniques, ink jetting, selective laser sintering, powder/binder jetting, electron beam melting, and stereolithographic processes. For each of these techniques, the digital representation of the 3D part is initially sliced into multiple horizontal layers. For each sliced layer, a tool path is then generated, which provides instructions for the particular additive manufacturing system to form the given layer.

For example, in an extrusion-based additive manufacturing system, a 3D part or model may be printed from a digital representation of the 3D part in a layer-by-layer manner by extruding a flowable part material. The part material is extruded through an extrusion tip carried by a print head of the system, and is deposited on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

Another type of 3D manufacturing system is selective toner electrophotographic process (STEP) additive manufacturing. In STEP layers of thermoplastic material are carried from electrophotography (EP) engine by a transfer medium (e.g., a rotatable belt or drum). The layer is then transferred to a build platform to print the 3D part (or support structure) in a layer-by-layer manner, where the successive layers are transfused together to produce the 3D part (or support structure). It is necessary to heat the thermoplastic material to an elevated temperature so that it will transfer from the transfer medium to a substrate (such as a partially formed part). It is important that the thermoplastic be heated high enough to transfer and fuse to the substrate or partially formed part, but also necessary that the thermoplastic material does not reach too high of temperature, and also that the transfer medium itself doesn't get too hot, because excessive heat can interfere with the transfusion process and can cause problems if the partially formed part becomes too hot. Those changes can include, for example, deformation of the overheated part.

Therefore a need exists for improvements to STEP manufacturing processes, including changes that improve upon the heating of the thermoplastic material before and during the transfusion process.

### SUMMARY

An aspect of the present disclosure is directed to an additive manufacturing system for creating a 3D part, in particular a selective toner electrophotographic process (STEP) additive manufacturing. In an example implementation the additive manufacturing system includes an imaging engine configured to develop an imaged layer of a thermoplastic-based powder, a movable build platform, and a transfer medium (e.g., a rotatable belt or drum) configured to receive the imaged layer from the imaging engine and to convey the received imaged layer to the build platform, where multiple imaged layers are built up to form a 3D part. The system also includes a transfusion assembly configured to transfer the heated imaged layer conveyed by the transfer medium onto the movable build platform by pressing the heated imaged layer between the transfer medium and the moveable build platform, and a cooling unit configured to actively cool the transferred layer.

The transfusion assembly also includes a heating assembly configured to heat the imaged layer on the transfer medium. The heating assembly typically includes a laser assembly configured to direct light towards portions of the additive manufacturing system, such as one or more laser bar emitters that direct laser light towards the nip formed between a transfer belt or roller and the surface of a partially formed part onto which the imaged layer of thermoplastic material is transferred. It will be understood that this “surface of a partially formed part” includes regions of build material that will form the final the part itself, but also can include regions of support material that will later be removed as well regions of no material at all (air) where neither build material or support material is present, such as between separate parts formed on a single support or openings within a part that do not require build material or support material. In this manner “surface” generally refers not to a continuous flat area of a single material, but represents a typically planar region corresponding to the top most portion of the part under production, and can include regions of build material, support material, and no material.

In an example implementation the system includes an apparatus for use in a selective toner electrophotographic process (STEP) additive manufacturing system, the apparatus comprising a radiant heat source configured to emit radiation of a first band of wavelengths in the region of a transfuse roller nip; and a pyrometer configured to receive and measure radiation emitted from the region of the transfuse roller nip; wherein the radiation measured by the pyrometer comprises a second band of wavelengths distinct from the first band of wavelengths emitted by the radiant heat source.

In embodiments the transfuse roller nip is formed between a transfer belt travelling along a nip roller and either a support surface or the top surface of a part being formed by the STEP additive manufacturing system.

In embodiments the pyrometer is configured to receive and measure black body emissions. In embodiments the apparatus allows for calculation of the temperature at the region of the transfuse roller nip. In embodiments the pyrometer is an imaging pyrometer. In embodiments the first band of wavelengths is less than 1 um. In embodiments the second band of wavelengths is from 8 to 14 um. In embodiments the apparatus further comprises a mount that points the pyrometer towards the transfuse roller nip that is being heated by the radiant heat source.

In embodiments the apparatus includes a wavelength selective device that allows radiation within the second band of wavelengths to be transmitted from the transfuse roller nip entrance to a sensor in the pyrometer, while constraining radiation within the first band of wavelengths. In embodiments the wavelength selective device comprises a silicon lens, plate, sheet, film, coating or other structure. In embodiments the apparatus includes more than one pyrometer, the pyrometers being oriented to measure the temperature at different portions of the transfusion nip.

In embodiments at least one pyrometer is oriented to measure temperature primarily on the image material on the transfer belt. In embodiments at least one pyrometer is oriented to measure temperature primarily on the support surface or part being manufactured.

In embodiments the radiant heat source comprises an array of lasers arranged in a row. In embodiments pyrometer is aligned intermediate a first radiant heat source and a second radiant heat source. In embodiments the apparatus uses asymmetry of the observed belt and part temperatures to steer the laser heating beams towards custom heating of the image surface and a part build surface. In embodiments the heating beams are directed so as to have equal heating between the image surface and part build surface.

The disclosure is also directed to a method for controlling measuring and controlling temperature of a transfuse roller nip, the method comprising: measuring the temperature of a transfuse roller nip of a STEP additive manufacturing system, the apparatus comprising a radiant heat source configured to emit radiation of a first band of wavelengths in the region of a transfuse roller nip; and a pyrometer configured to receive and measure radiation emitted from the region of the transfuse roller nip; wherein the radiation measured by the pyrometer comprises a second band of wavelengths different from the first band of wavelengths emitted by the radiant heat source; modifying the delivery of radiation from the first radiant heat source based upon the measurement of radiation emitted and measured by the pyrometer. In embodiments modifying the delivery of radiation comprises changing the intensity of the radiation. In embodiments modifying the delivery of radiation comprises changing the location of the radiation. In embodiments modifying the delivery of radiation comprises changing the duration of application of the radiation.

Another aspect of the present disclosure is directed to a method for printing a three-dimensional part with a STEP additive manufacturing system. The method includes imaging a layer of the 3D part from a thermoplastic-based powder, transferring the imaged layer to a transfer medium, and heating the imaged layer with laser light while the imaged layer is retained on the transfer medium. The method also includes transfusing the heated layer to a top surface of the 3D part such that the heated layer releases from the transfer medium and defines a new top surface of the 3D part, followed by cooling the 3D part with the new top surface.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic illustration of an electrophotography-based additive manufacturing system of the present disclosure having a layer transfusion assembly

FIG. 2 is a graphical representation of nip entrance geometry of an example construction.

FIG. 3 is a schematic illustration of a portion of a transfusion assembly constructed in accordance with various embodiments herein, showing the transfusion assembly before creation of a 3D part.

FIG. 4 is a schematic illustration of a portion of a transfusion assembly constructed in accordance with various embodiments herein, showing the transfusion assembly during initial stages of creation of a 3D part.

FIG. 5 is a schematic illustration of a portion of a transfusion assembly constructed in accordance with various embodiments herein, showing the transfusion assembly during initial stages of creation of a 3D part.

FIG. 6 is a schematic illustration of a portion of a transfusion assembly constructed in accordance with various embodiments herein, showing the transfusion assembly after further stages of creation of a 3D part.

FIG. 7 is a schematic illustration of a portion of a transfusion assembly constructed in accordance with various embodiments herein, showing a system having a photometer without a separate filter.

FIG. 8 is a schematic illustration of a portion of a transfusion assembly constructed in accordance with various embodiments herein, showing a system with lenses to control and direct laser light.

FIG. 9 is a schematic illustration of a portion of a transfusion assembly constructed in accordance with various embodiments herein, showing a system with laser bars with independent orientation adjustment.

FIG. 10 is a schematic illustration of a portion of a transfusion assembly constructed in accordance with various embodiments herein, showing a system with laser bars with combined orientation adjustment.

FIG. 11 is a schematic illustration of a portion of a transfusion assembly constructed in accordance with various embodiments herein, showing a system with laser bars with individual and combined orientation adjustment.

FIG. 12A is a simplified graph showing nip temperature measurement using infrared radiation measured at an imaging pyrometer, showing maximum temperature at a position above the nip position on the Z-axis.

FIG. 12B is a simplified graph showing nip temperature measurement using infrared radiation measured at an imaging pyrometer, showing maximum temperature at a position below the nip position on the Z-axis.

FIG. 12C is a simplified graph showing nip temperature measurement using infrared radiation measured at an imaging pyrometer, showing maximum temperature at a position at the nip position on the Z-axis.

FIG. 13 is a schematic illustration of a portion of a transfusion assembly constructed in accordance with various embodiments herein, showing an intermittent laser heater.

FIG. 14 is a schematic illustration of a portion of a transfusion assembly constructed in accordance with various embodiments herein, showing two transfer rollers.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Nip entrance temperature is an important indicator and control variable for STEP manufacturing, including part strength of objects made using STEP manufacturing equipment and processes. Therefore careful application of energy to STEP manufacturing components (such as the transfer belt, thermoplastic material on the belt, and the adjacent partially constructed part) is important. Laser heating, using laser beams to heat components near the nip, has significant advantages, including control of the amount, location, and timing of heating that occurs. Further, the nip entrance temperature can be readily determined by imaging the infrared emission from the nip entrance onto a pyrometer (or other thermosensor array).

An objective with regard to using laser heating, such as 808 nm or 930 nm or 980 nm wavelengths, is to achieve heating from 120 degrees Celsius to 280 degrees Celsius in a very short period of time, such a 0.06 sec prior to arriving at the nip. Using the laser heating apparatus and method described herein it is possible to change from carbon black to an infrared dye, allowing for non-black parts. It is desirable, in some embodiments, to switch the heat on and off in 5 msec, constraining heat to just the part build surface. Lasers heating is also desirable because it provides collimated heating instead of isotropic heat, reducing anomalous edge heating. Further, laser heating allows for reduced heat penetration depth from about 20 mils to about 4 mils, making it easier to subsequently cool the part build surface.

The laser sheet thickness produced by the laser bars with their collimating cylindrical lenses is often about 8 mm, therefore the laser needs to be steered so that it deposits the correct amount of energy below and above the line of the nip. Variations in part height can be +/−50 mils, or more than a millimeter. If the laser hits the image more than the part surface, the image will be substantially hotter than the part surface at the nip entrance, and vice versa. Therefore, careful control of the heating process is necessary, including the precise location and timing of application of heating energy.

Another aspect of the present disclosure is directed to an additive manufacturing system for printing a 3D part, where the additive manufacturing system includes an imaging engine configured to develop imaged layers of a thermoplastic-based powder, a movable build platform, and a rotatable transfer belt having a transfer surface and an opposing contact surface. The transfer surface is configured to receive the imaged layers from the imaging engine in a successive manner, and to convey the received image layers to the build platform in a successive manner. The system also includes a first heating assembly (typically a laser heating assembly) configured to heat the imaged layers on the transfer surface in a successive manner, a roller configured to transfuse the heated imaged layers conveyed by the transfer medium in a successive manner onto the movable build platform by engaging and rolling across the contact surface of the rotatable belt, and a cooling unit configured to actively cool the transfused layers in a successive manner.

The present disclosure is further directed to a layer transfer technique for printing 3D parts and support structures in a layer-by-layer manner, where each layer is printed from a part or support material in a thermally-controlled manner. The layer transfer technique is performed with an imaging system, such as an electrophotography-based additive manufacturing system. For example, each layer may be developed or otherwise imaged using electrophotography and carried from an electrophotography (EP) engine by a transfer medium (e.g., a rotatable belt or drum). The layer is then transferred to a build platform to print the 3D part (or support structure) in a layer-by-layer manner, where the successive layers are transfused together to produce the 3D part (or support structure).

In comparison to 2D printing, in which developed toner particles can be electrostatically transferred to printing paper by placing an electrical potential through the printing paper, the multiple printed layers in a 3D environment effectively prevents the electrostatic transfer of part and support materials after a given number of layers are printed (e.g., about 15 layers). Instead, in the present disclosure, a layer retained by the transfer medium is heated to an elevated transfer temperature by laser light. The heated layer is then pressed against a previously printed layer (or to a build platform) to transfuse the layers together (i.e., a transfusion step). This allows numerous layers of 3D parts and support structures to be built vertically, beyond what is otherwise achievable via electrostatic transfers.

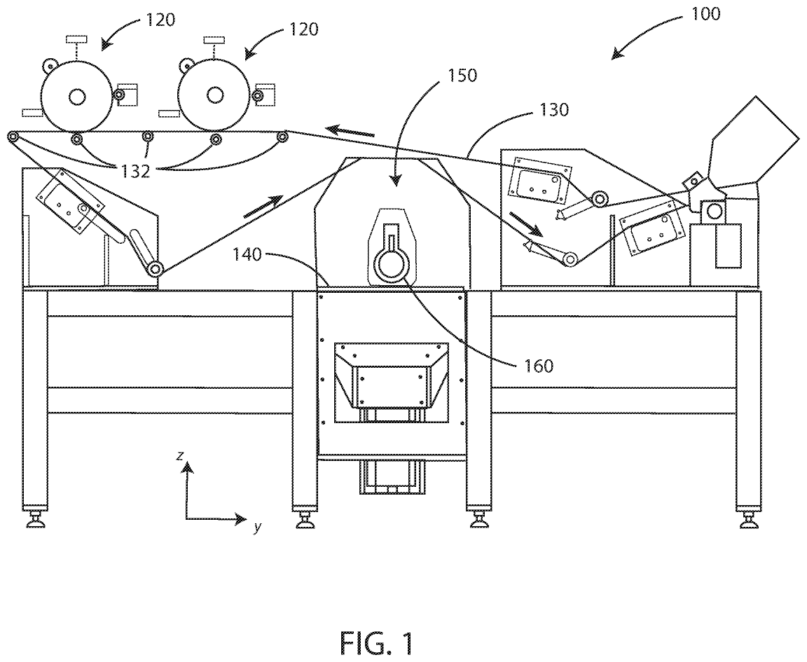

Referring to FIG. 1, a simplification of STEP printing system 100 is shown in schematic form, the system 100 is an example additive manufacturing system for printing 3D parts and support structures using electrophotography (EP), which incorporates a layer transfer technique. In the example embodiment system 100 includes electrophotographic (“EP”) engines 120, transfer belt 130, rollers 132, build platform 140 and transfusion assembly 150 including nip roller 160 for printing 3D parts (e.g., 3D part) and any associated support structures (not shown). Examples of suitable components and functional operations for system 100, without limitation, include those disclosed in U.S. patent application Ser. Nos. 13/242,669 and 13/242,841.

In alternative embodiments, system 100 may include different imaging engines and transfer components for imaging the layers. The layer transfer technique focuses on the transfer of layers from belt 130 (or other transfer medium) to build platform 140 (or to the 3D part being printed on build platform 140) at nip formed between the roller 160 and the platform 140 (or the top surface of a part under construction). The layer transfer technique is particularly suitable for use with electrophotography based additive manufacturing systems (e.g., system 100), where the multiple printed layers in a 3D environment effectively prevents electrostatic transfer of part and support materials after a given number of layers are printed, as discussed above.

System 100 also includes a controller, which is one or more control circuits, microprocessor-based engine control systems, and/or digitally-controlled raster imaging processor systems, and which is configured to operate the components of system 100 in a synchronized manner based on printing instructions received from host computer. A host computer is one or more computer-based systems configured to communicate with controller to provide the print instructions (and other operating information). For example, a host computer may transfer information that relates to the sliced layers of 3D part (and any support structures), thereby allowing system 100 to print 3D part in a layer-by-layer manner.

Each EP engine 120 (of which there can be one or more) is configured to develop or otherwise image successive layers of a thermoplastic based powder using electrophotography. The thermoplastic-based powder includes one or more thermoplastic materials (e.g., an acrylonitrile-butadiene-styrene (ABS) copolymer), and may also include one or more additional components for development with EP engine 120 and electrostatic attraction to belt 130. The imaged layers of the thermoplastic-based powder are then rotated to a first transfer region in which layers are transferred from EP engine 120 to belt 130.

Belt 130 is an example transfer medium for transferring or otherwise conveying the imaged layers from EP engine 120 to build platform 140. In some embodiments belt 130 may be a multiple layer belt with a low-surface-energy film.

System 100 may also include one or more biasing mechanisms, which are configured to induce an electrical potential through belt 130 to electrostatically attract layers of the thermoplastic based powder from EP engine 120 to belt 130. Because layers of the thermoplastic are each only a single increment layer in thickness at this point in the process, electrostatic attraction is suitable for transferring layers from EP engine 120 to belt 130. However, the multiple printed layers for 3D part effectively prevents electrostatic transfer of layers from belt 130 to build platform 140 after a given number of layers are printed, therefore electrostatic transfer works for transferring layers of thermoplastic material to the belt 130, but generally does not have a major role in transferring them electrostatic material to the build platform 140 or a partially manufactured parts.

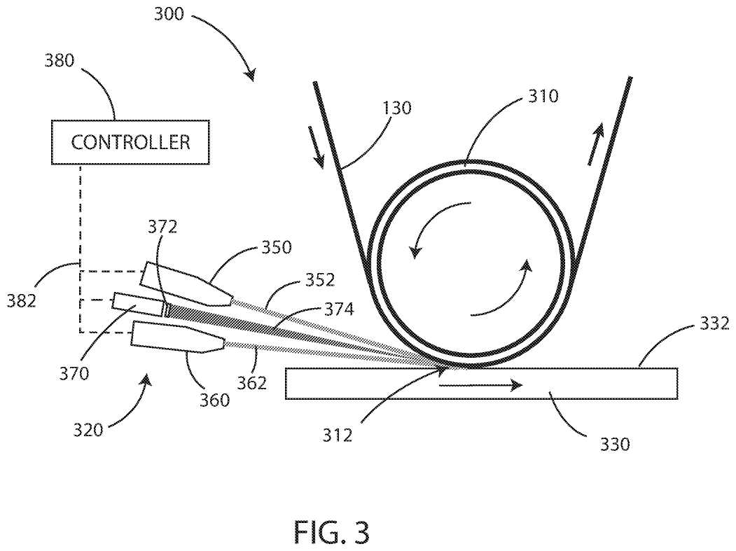

Rollers, such as series of drive and/or idler rollers or pulleys, can be configured to maintain tension on belt 130 while belt 130 rotates in the rotational directional of arrows. This allows belt 130 to maintain a substantially planar orientation when engaging the part build surface. System 100 may also include various service loops, such as those disclosed in U.S. patent application Ser. No. 13/242,841. Build platform 140, roller 160, and heating any heating assembly (see FIGS. 3 to 14) may collectively be referred to as layer transfusion assembly 33. Layer transfusion assembly 33 is configured to transfuse the heated layers of thermoplastic material from the belt 130 to the previously-transfused layers of a 3D part (or onto build platform 140) in a layer-by-layer manner.

Build platform 140 is a platform assembly or platen of system 100 that is configured to receive the heated layers of thermoplastic material for printing 3D part in a layer-by-layer manner. Build platform 140 is (in an example configuration) supported by a gantry, which is a linear guide mechanism configured to incrementally lower build platform 140 along the vertical z-axis relative to belt 130 after each pressing step. The movement of build platform 140 with gantry is operated by a z-axis motor. In some embodiments build platform 140 may include removable film substrates for receiving the printed layers.

The build platform 140 is optionally heatable with a heating element (e.g., an electric heater). The heating element can be configured to heat and maintain the build platform 140 at an elevated temperature that is greater than room temperature (25 degrees Celsius), such as at the desired average part temperature of 3D part. This allows build platform 140 to assist in maintaining 3D part at this average part temperature.

The average part temperature for the 3D part is desirably high enough to promote interlayer adhesion and to reduce the effects of curling, while also being low enough to prevent the 3D part from softening too much (i.e., below its deformation temperature). Suitable average part temperatures for 3D parts range from greater than the average solidification temperature of the thermoplastic material(s) of the thermoplastic-based powder to about the glass transition temperature of the thermoplastic material(s). More desirably, the average part temperature is maintained at about the creep relaxation temperature of the thermoplastic material(s) of the thermoplastic-based powder, or within about 10 degrees Celsius above or below thereof. Examples of suitable techniques for determining the creep relaxation temperatures of materials are disclosed in Batchelder et al., U.S. Pat. No. 5,866,058.

In some preferred embodiments, the average part temperature is maintained in a range between the creep relaxation temperature of the thermoplastic material(s) of the thermoplastic-based powder and a maximum allowable solidification temperature, where the maximum allowable solidification temperature may be illustrated by the stress relaxation of the thermoplastic-based powder. For example, when printing layers of an ABS copolymer-based powder, the average part temperature for 3D part may be about 100 degrees Celsius, as may be appreciated by a comparison of the stress relaxation or Young's modulus versus temperature for the composition.

As such, maintaining a 3D part at an average part temperature below the Young's modulus drop for its composition allows 3D part to maintain its structural integrity when pressed between build platform 140 and roller nip during subsequent transfusion steps. Furthermore, when the top-most layer of 3D part is maintained at this temperature and receives a heated layer at a fusion temperature of about 200 degrees Celsius, the transfusion interface temperature for transfusing the layers together starts at about 150 degrees Celsius.

As mentioned above, the particular pressure applied during each transfusion step is desirably high enough to adhere the heated layer to the previously-transfused layer (or to build platform 140), allowing the polymer molecules to at least partially interdiffuse.

System 100 may also include one or more air knives or other cooling units, where an air knife is an example cooling unit configured to blow localized cooling air to the top layers of 3D part. The air knife can be located adjacent to the lateral side of build platform 140 to direct the cooling air laterally relative to the direction of movement of belt 130. This allows the air knife to extend along the entire length of the 3D part, providing good air flow over the top layers of 3D part, including the fused layer.

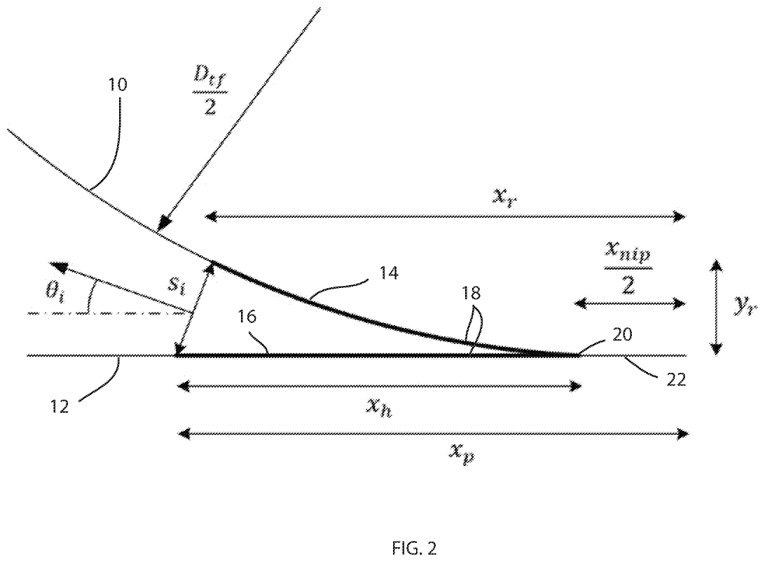

FIG. 2 shows nip entrance geometry including image material area 10 with image material prior to passage to the nip area, the image material area 10 can include, for example, various part materials; support materials; or air (absence of part or support material) on top of a belt, in turn located on top of the transfuse roller (see, e.g. FIG. 3); In addition, below this image material area 10 is part build surface 12, which also includes various part materials, support materials, and air. Thus, image material area 10 includes the material that is to be deposited onto the build surface 12, while build surface 12 represents prior layers of material that have already been deposited and transfused (or in the case of a first layer, the build substrate). The image material area 10 and the build surface 12 are moving toward the transfuse roller nip entrance 20. The image material and build surface eventually reach regions of heating: image heating region 14 and build surface heating region 16; both of which are heated by a radiant heat source (such as a laser heater); The lasers themselves are typically directed toward a target region 18 adjoining the nip entrance 20 (often comprising both portions of the image material and the part build surface near the nip entrance). As the build process continues the image material and part build surface travel past the nip entrance and to the front area 22 of the nip 20. The part build surface is subsequently repositioned relative to the belt and roller and additional layers of image material are deposited repeatedly until the part is formed.

FIG. 3 is a simplified schematic illustration of a portion of a transfusion assembly 300 constructed in accordance with various embodiments herein (an example of the transfusion assembly 150 from FIG. 1), showing the transfusion assembly 300 before creation of a 3D part. The transfusion assembly 300 includes a transfuse roller 310, in contact with a belt 130 that wraps around the bottom of the transfuse roller 310. The direction of rotation of the transfuse roller 310 and the belt 130 are shown by arrows, with the belt moving from left to right in the depicted figure on the transfuse roller 310 that is rotating counter clockwise.

As the belt 130 travels through the system 100 (see FIG. 1) it picks up thermoplastic material at the EP engine(s) 120 and then travels along the belt 130 to the bottom of the transfuse roller 310, where it is in proximity to the top surface 332 of a platen 330. In this depicted embodiment the platen moves in the same direction, and at the same speed, as the belt 130 and transfuse roller 310. The thermoplastic material on the belt 130 is then transferred to the top of the platen 330 or to a partially formed part on the platen. Thus, as layers of thermoplastic material are built up the thermoplastic material is deposited on top of prior layers of thermoplastic material to form a part. The transfuse roller and the platen gradually move apart from one another as the part is built up. This movement can be accomplished in numerous ways—such as lowering the platen 330 or raising the transfuse roller 310, or by having the platen 330 move between multiple transfuse assemblies 300, each with a slightly greater distance between the belt 130 and roller 310 and platen 330 to accommodate for the deposit of layers of thermoplastic material.

Also shown in FIG. 3 is a heating assembly 320. Heating assembly 320 provides carefully regulated heat to the nip between the transfuse roller 310 and the platen 330 or part (not shown in FIG. 3, but shown below). The heating assembly 320 typically includes at least one, and optionally two or more, laser light sources, such as laser bar arrays 350 and 360. The laser bar arrays 350, 360 are configured to direct laser light into the nip 312 at the base of the roller. The light from the laser bar arrays heats the thermoplastic material on the belt 130 and the platen or part below the belt to temperature suitable for transfer of the thermoplastic material and fusing it to the platen or partially formed part below.

The fusion temperature is a temperature that sufficiently melts the thermoplastic-based powder to a fusable state. Thus, the fusion temperature will vary depending on the particular layer material used and other variables. For example, for an ABS copolymer material, the fusion temperature may range from about 180 degrees Celsius to about 280 degrees Celsius depending on the particular copolymer composition. Heating the thermoplastic-based powder to the fusion temperature does not necessarily require every component of the thermoplastic-based powder to melt. Rather, the overall thermoplastic-based powder needs to reach a fusable state for subsequent transfusion. This typically refers to the one or more thermoplastic materials of the thermoplastic-based powder being sufficiently melted to the fusable state.

The heating assembly 320 is shown with laser beams 352 and 362 extending from laser bar arrays 350 and 360 respectively. The construction shown in FIG. 3 shows the laser beams in a cross section as a narrow band, and it will be understood that in typical use light coming out of each laser bar array 350, 360 create a wide band or sheet of laser light that extends across much or all of the width of the belt 130.

The heating assembly 320 further includes an imaging pyrometer 370 or other device for measuring the temperature at the nip 312. The imaging pyrometer 370 receives light 374 (represented as a beam, but in actual implementation is a broad area of emitted infrared light). A filter, such as a silicon plate 372 may be positioned in the light path between the nip 312 and the imaging pyrometer 370 to filter out reflected or scattered laser light from the laser bar arrays 350 and 360. In example implementations the laser bar arrays 350, 360 emit light at wavelengths between 800 and 950 nm, such as at 808 nm or 930 nm or 980 nm. In typical implementations the laser bar arrays 350, 360 have the same wavelength of light coming from all lasers in both arrays, although the laser bar arrays 350, 360 can have different wavelengths in some embodiments.

The use of the laser bar arrays 350, 360 allows for very precise heating, including precise position of the laser light to only heat up portions of the belt 130 and platen 330 or part. One particular advantage is the ability to apply the laser light to bring the thermoplastic material up to transfusion temperature very quickly before the thermoplastic material reaches the nip 312. This rapid heating by carefully controlled application of laser light avoids delivering excess thermal energy to the carrier belt 130 or the platen 330 (or partially formed part). The reduced delivery of energy means that the belt, platen, and part do not undergo unnecessary and undesirable heating, which can occur as a part becomes larger with the deposit of numerous layers of thermoplastic material. Although there are ways to remove some of that excess heat from the roller, platen and part, such methods often involve blowing of cooling air onto these components after they pass through the nip 312, and this cooling can itself be challenging because it is somewhat imprecise and can itself distort the part geometry. A controller 380 is in communication with the heating assembly 320 by means of communication means 382, which is typically wires but optionally wireless communication means.

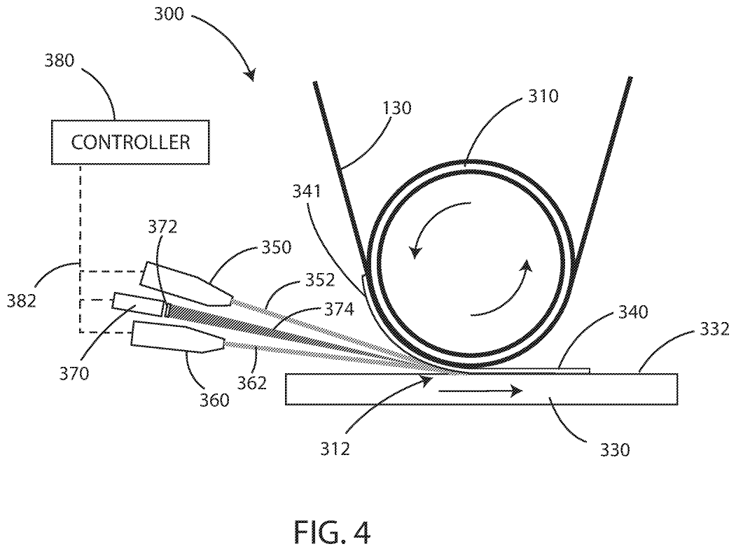

Now referring to FIG. 4, a simplified schematic of the transfusion assembly 300 shows the transfusion assembly during initial stages of creation of a 3D part by showing layer 340 of thermoplastic material having been deposited to start forming a part. In fact each layer of thermoplastic material is very thin, so the representation in FIG. 4 and other figures is not shown to scale, and in fact the layer is much thinner than represented. FIG. 4 shows how some of the thermoplastic material is still retained on the belt in an upstream layer 341. Thus, FIG. 4 shows a mid-point view of the deposit of thermoplastic material, with part of the thermoplastic material having been deposited as layer 340 onto the top surface 332 of the platen, while other portions of the thermoplastic material are still on the belt 130 and form upstream layer 341. Between these two sections is the nip 312 where the laser light beams 352, 362 from laser bar arrays 350, 360. It is at the nip 312 that (in this embodiment) the thermoplastic material is transfused onto the platen 330 (or top of a part, as shown in subsequent figures below). The laser light beams 352, 362 provide the necessary heat to bring the thermoplastic material up to an appropriate temperature for transfusion to occur. Also shown in FIG. 4 is how light 374 emitted from the nip 312 is measured at the imaging pyrometer 370. The light coming from the nip 312 is typically a combination of reflected laser light and infrared light emitted from the heated materials and surfaces. The silicon plate 372 filters out the laser light while allowing the infrared light to pass through, and the imaging pyrometer provides thermal data that is used with the controller 380 to monitor performance and regulate application of laser light from laser bar arrays 350, 360.

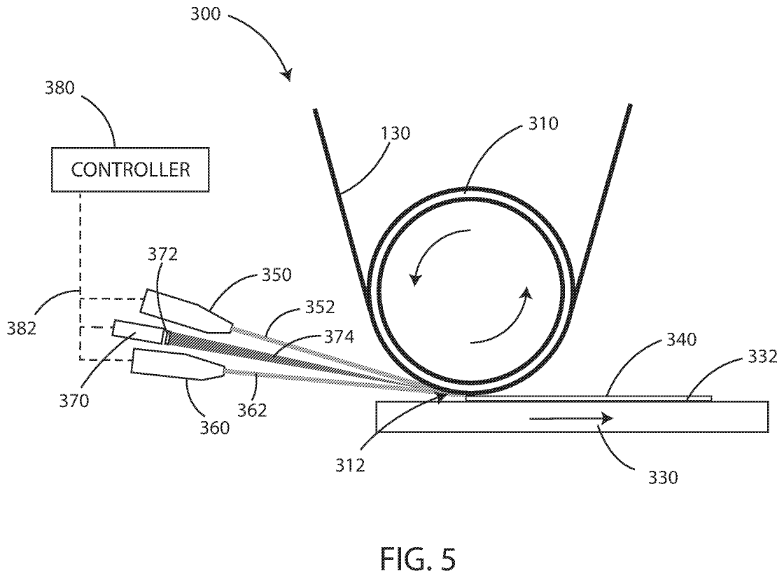

FIG. 5 is a simplified schematic illustration of a portion of the transfusion assembly 300 constructed in accordance with various embodiments herein, showing the transfusion assembly during initial stages of creation of a 3D part, with the platen 330 having advanced beyond that shown in FIG. 4 to form a whole layer 340 of deposited and transfused thermoplastic material.

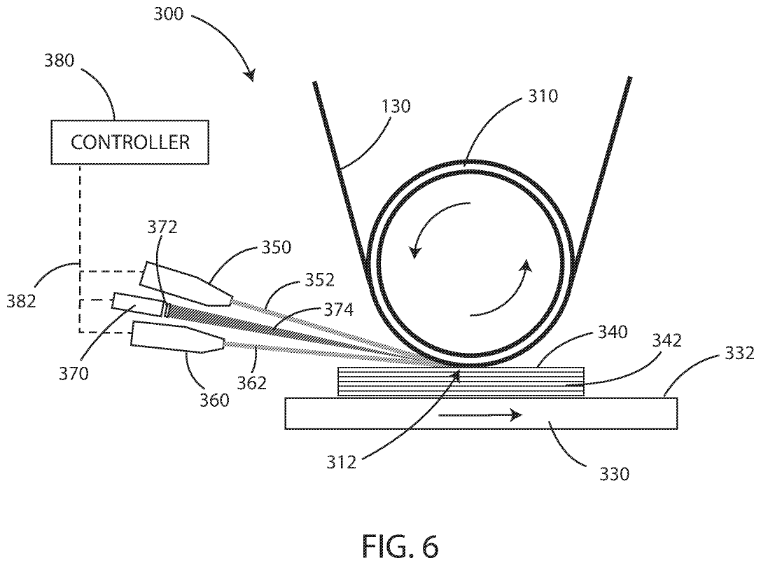

FIG. 6 shows the transfusion assembly 300 after further stages of creation of a 3D part 342, of which a top layer 340 is shown (the top layer 340 being the most recently deposited layer). As noted above, FIG. 6 is not drawn to scale, and an actually part will often have hundreds of layers of thermoplastic deposited.

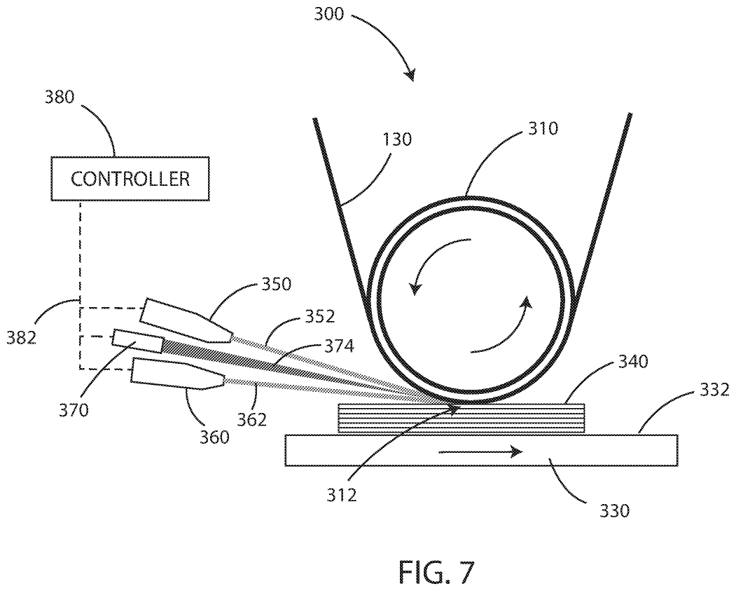

FIG. 7 is a simplified schematic illustration of a portion of the transfusion assembly 300, but showing the system having a photometer without a separate filter for elimination of the reflected laser light. The lack of an external filter can be accomplished, for example, by using an internal filter within the imaging pyrometer 370, by using an imaging pyrometer 370 that has selective measurement of only infrared wavelengths, or by other techniques. For example, if the laser bar emitters 350, 360 are being rapidly cycled to deliver laser light in bursts or intermittent emissions, then the imaging pyrometer 370 can be configured (by way of controller 380) to only include measurements when laser light is not being emitted. Such methodologies require rapid response rates for the imaging pyrometer 370.

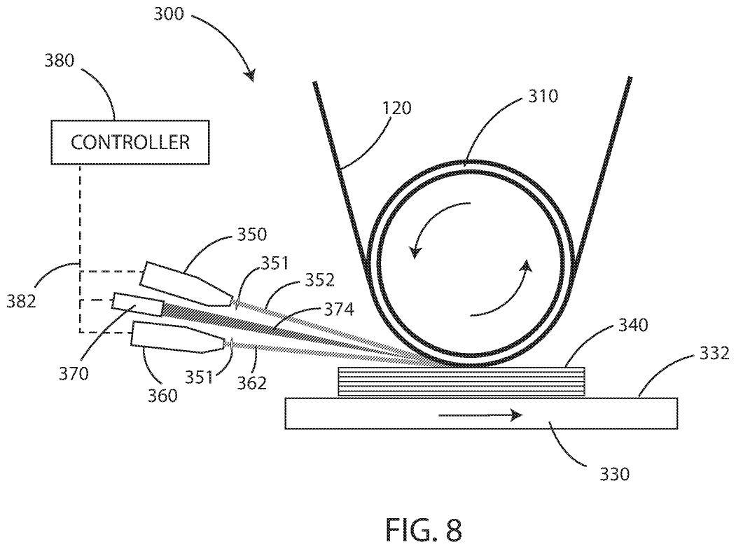

As discussed above, it is possible to modify the basic structure in various ways without deviating from the overall typical construction that uses laser light to provide the transfusion heat, while also generally using a thermal imaging system to measure the nature of that heating, such as to measure the temperature of the transfer belt, the nip, the part being formed and/or the platen on which the part is being formed. Example alternative/additional designs are shown in FIGS. 8 to 11 and 13. FIG. 8 is a simplified schematic illustration of a portion of the transfusion assembly 300 but also showing lenses 351 that control and direct the laser light 352, 362. Such lenses can be used in various ways, such as to narrow and further focus the laser beams, to direct the laser beams slightly up or down, etc. Although such lenses may be used in some embodiments, their use is optional and not necessary in other embodiments.

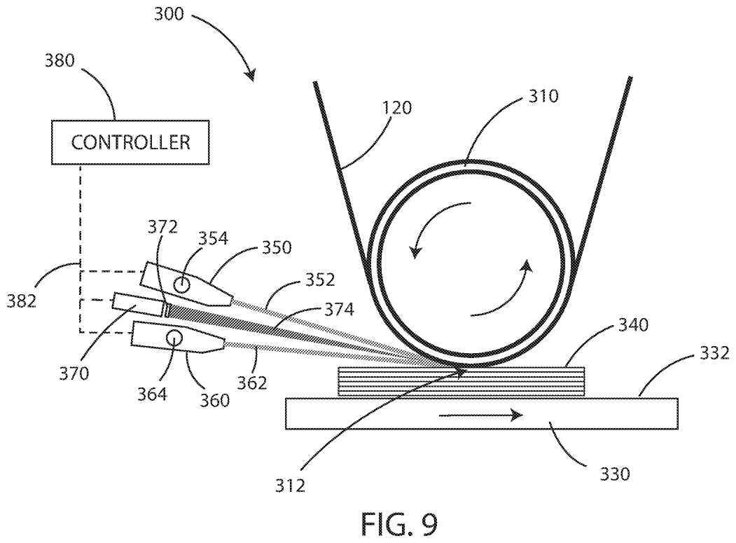

FIG. 9 shows the transfusion assembly 300 with an assembly where the laser bar emitters 350, 360 include adjustment means 354, 364 for independent orientation adjustment of the bar emitters 350, 360 to slightly change the orientation of the emitters 350, 360 and thereby modify precisely where they hit near the nip 312. The adjustment means 354, 364 can be as simple as an axis around which the emitters 350, 360 can pivot when assembling or tuning the transfusion assembly, such adjustments made manually by a technician. Alternatively, the adjustment means 354, 364 are controllable in real time, such as by response to the readings received by the imaging pyrometer 370 and interpreted by the controller 380. This control allows each of the laser bar emitters 350, 360 to be carefully directed, even in real time, to provide the proper amount and location of laser light energy to the belt, nip, and part. Such adjustments can become necessary, for example, due to slight changes in position of the various components during operation, such as thermal expansion and contraction from raising and lower temperatures, etc. For example, a real time reading of infrared emissions from the imaging pyrometer 370 may show that the top layer of the part being produced is warming up more than necessary and desired, but that the thermoplastic material on the belt 130 before the transfusion step is slightly cooler than desired. In such circumstance orientation of one or both of the laser bar emitters can be changed to redirect the laser beams 352, 362. It is also possible to vary the intensity of these laser beams 352, 362 to sometimes accomplish the same result (such as increasing intensity of beam 352 while decreasing intensity of beam 362, or vice versa), but slight adjustment using adjustment means 354, 364 provides an additional way of controlling and regulating the heating process.

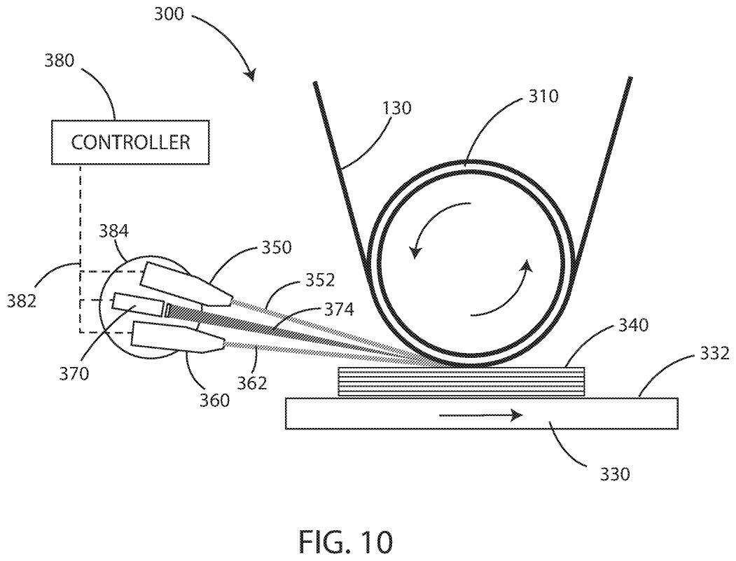

FIG. 10 is similar to the construction shown in FIG. 9, with a portion of transfusion assembly 300, but here the laser bars 350, 360 have a combined orientation adjustment means 384. This combined adjustment means 384 can comprise, for example, a mounting rack that allows for the two laser bar emitters 350, 360 to be simultaneously and identically adjusted by pivoting both of them at once.

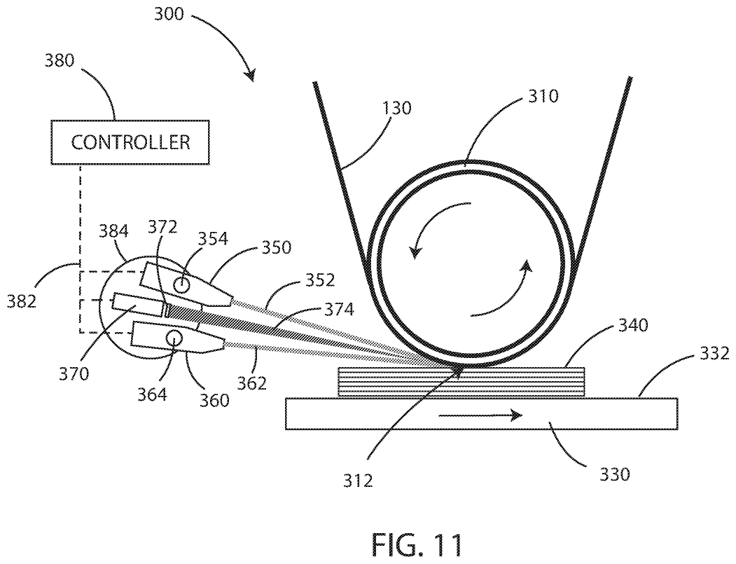

FIG. 11 shows a system that allows for both combined and independent adjustment, using features of both FIG. 9 and FIG. 10.

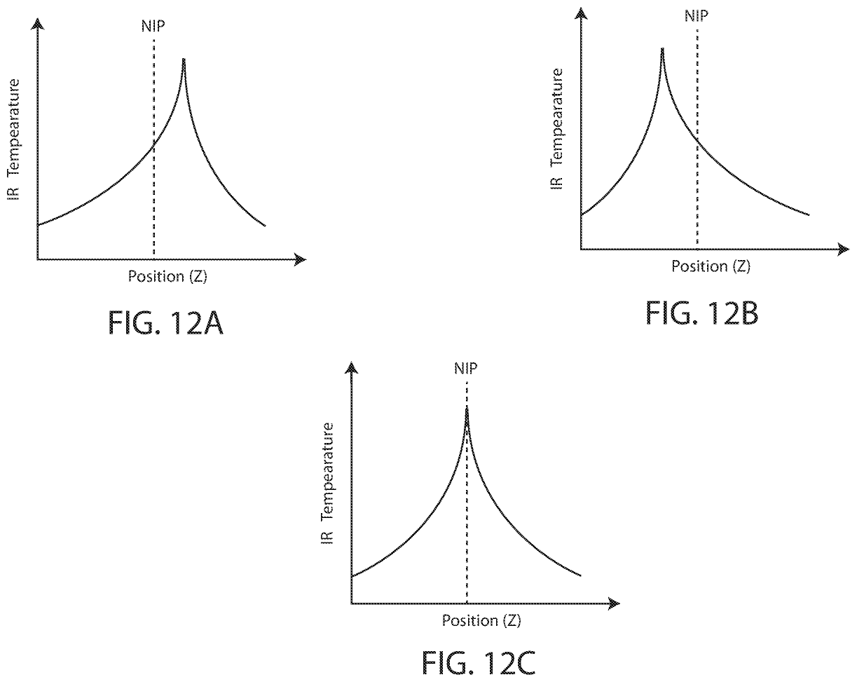

FIGS. 12A to 12C show how adjustment of the laser heating components can be beneficial. FIG. 12A is a simplified graph showing nip temperature measurement using infrared radiation measured at an imaging pyrometer, showing maximum temperature at a position above the nip position on the Z-axis. FIG. 12B is a simplified graph showing nip temperature measurement using infrared radiation measured at an imaging pyrometer, showing maximum temperature at a position below the nip position on the Z-axis. FIG. 12C is a simplified graph showing nip temperature measurement using infrared radiation measured at an imaging pyrometer, showing maximum temperature at a position at the nip position on the Z-axis. This last arrangement, shown in FIG. 12C, is typically preferred because the maximum desired temperature should occur at the point of transfusion, which is at the nip. Adjustment of the position of the laser beams can provide for optimal heating.

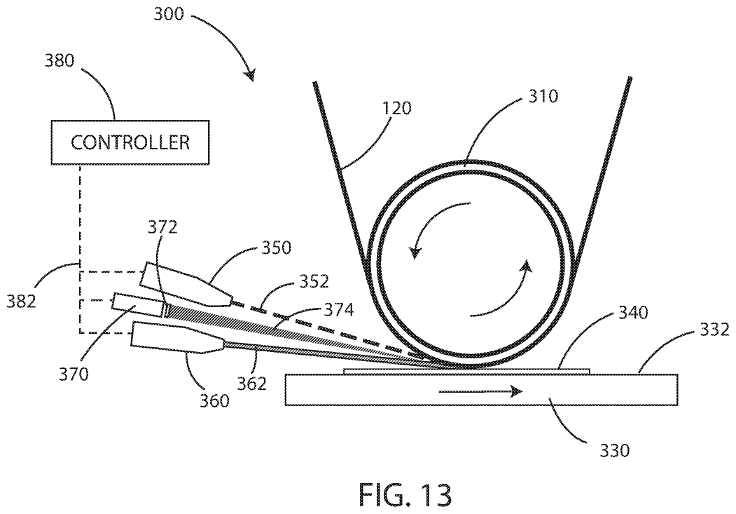

FIG. 13 is a simplified schematic illustration of a portion of a transfusion assembly constructed in accordance with various embodiments herein, showing an intermittent laser heater 350 with a constant heater 360. This embodiment is shown to demonstrate how the two laser bar emitters 350, 360 (or additional laser bar emitters) can be controlled independently of one another, and how the emitted light can be constant, pulsed, etc. The variation in timing and intensity of emitted light can be used to provide improved transfusion performance.

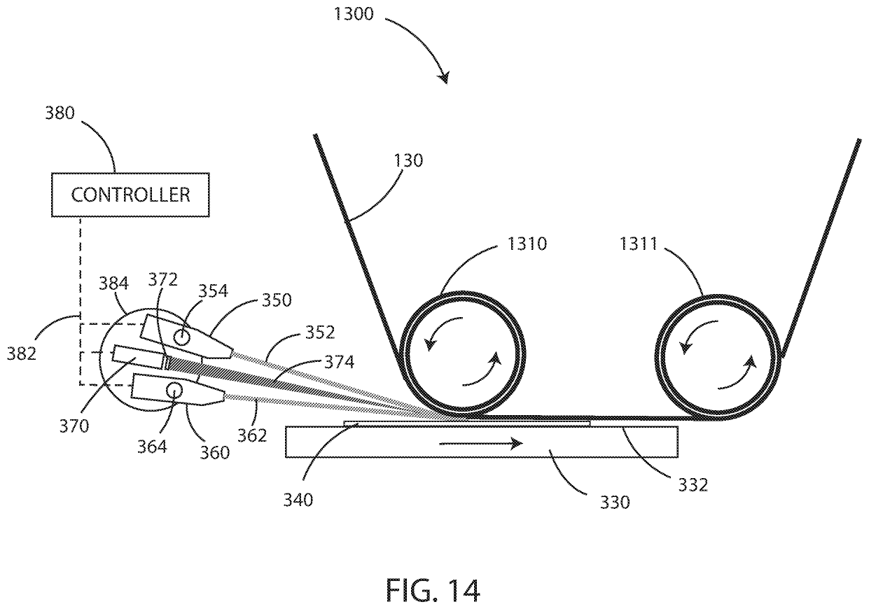

FIG. 14 is a simplified schematic illustration of a portion of a transfusion assembly 1300 constructed in accordance with various embodiments herein, showing two rollers 1310, 1311. This construction is shown as an alternative to the single roller construction. Also, it will be appreciated that additional alternations can be made, for example different platen 330 designs may be used, press-plates can be used to bring the part and belt in contact with one another, etc. Thus, the laser heating constructions and assemblies can be used with a wide range of systems 100.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms “about” and “substantially” are used herein with respect to measurable values and ranges due to expected variations known to those skilled in the art (e.g., limitations and variabilities in measurements).

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

The terms “transfusion”, “transfuse”, “transfusing”, and the like refer to the adhesion of layers with the use of heat and pressure, where polymer molecules of the layers at least partially interdiffuse.

The term “transfusion pressure” refers to a pressure applied during a transfusion step, such as when transfusing layers of a 3D part together.

The term “deformation temperature” of a 3D part refers to a temperature at which the 3D part softens enough such that a subsequently-applied transfusion pressure, such as during a subsequent transfusion step, overcomes the structural integrity of the 3D part, thereby deforming the 3D part.

Directional orientations such as “above”, “below”, “top”, “bottom”, and the like are made with reference to a direction along a printing axis of a 3D pan. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An apparatus for use in a selective toner electrophotographic process (STEP) additive manufacturing system, the apparatus comprising:
a radiant heat source configured to emit radiation of a first band of wavelengths in the region before a transfuse roller nip; and
a pyrometer configured to receive and measure radiation emitted from the region of the transfuse roller nip;
wherein the radiation measured by the pyrometer comprises a second band of wavelengths different from the first band of wavelengths emitted by the radiant heat source.

2. The apparatus of any of claims 1 and 3-19, wherein the transfuse roller nip is formed between a transfer belt travelling along a nip roller and either a support surface or the top of a part being formed by the STEP additive manufacturing system.

3. The apparatus of any of claims 1-2 and 4-19, wherein the pyrometer is configured to receive and measure black body emissions.

4. The apparatus of any of claims 1-3 and 5-19, wherein the apparatus allows for calculation of the temperature at the region of the transfuse roller nip entrance.

5. The apparatus of any of claims 1-4 and 6-19, wherein the pyrometer is an imaging pyrometer.

6. The apparatus of any of claims 1-5 and 7-19, wherein the first band of wavelengths is less than 1 um.

7. The apparatus of any of claims 1-6 and 8-19, wherein the second band of wavelengths is from 8 to 14 um.

8. The apparatus of any of claims 1-7 and 9-19, further comprising a mount that points the pyrometer towards the transfuse roller nip that is being heated by the radiant heat source.

9. The apparatus of any of claims 1-8 and 10-19, further comprising a wavelength selective device that:
allows radiation within the second band of wavelengths to be transmitted from the transfuse roller nip entrance to a sensor in the pyrometer,
while constraining radiation within the first band of wavelengths.

10. The apparatus of any of claims 1-9 and 11-19, wherein the wavelength selective device comprises silicon lens, plate, sheet, film, coating or other structure.

11. The apparatus of any of claims 1-10 and 12-19, wherein the apparatus includes more than one pyrometer, the pyrometers being oriented to measure the temperature at different portions of the transfusion nip.

12. The apparatus of any of claims 1-11 and 13-19, wherein at least one pyrometer is oriented to measure temperature primarily on the transfer belt.

13. The apparatus of any of claims 1-12 and 14-19, wherein at least one pyrometer is oriented to measure temperature primarily on the support surface or part being manufactured.

14. The apparatus of any of claims 1-13 and 15-19, wherein the radiant heat source comprises a laser.

15. The apparatus of any of claims 1-14 and 16-19, wherein the radiant heat source comprises an array of lasers arranged in a row.

16. The apparatus of any of claims 1-15 and 17-19, wherein the pyrometer is aligned intermediate a first radiant heat source and a second radiant heat source.

17. The apparatus of any of claims 1-16 and 18-19, comprising two pyrometers: a first pyrometer located above one or more radiant heat sources and a second pyrometer located below the radiant heat source.

18. The apparatus of any of claims 1-17 and 19, wherein the apparatus uses asymmetry of the observed belt and part temperatures to steer the laser heating beams towards custom heating of the image surface and a part build surface.

19. The apparatus of any of claims 1-18, wherein laser heating beams are directed so as to have equal heating at the nip entrance between the image surface and part build surface.

20. A method for controlling measuring and controlling temperature of a transfuse roller nip, the method comprising:
measuring the temperature of a transfuse roller nip of a selective toner electrophotographic process (STEP) additive manufacturing system, the apparatus comprising a radiant heat source configured to emit radiation of a first band of wavelengths in the region of a transfuse roller nip; and a pyrometer configured to receive and measure radiation emitted from the region of the transfuse roller nip; wherein the radiation measured by the pyrometer comprises a second band of wavelengths different from the first band of wavelengths emitted by the radiant heat source;
modifying the delivery of radiation from the first radiant heat source based upon the measurement of radiation emitted and measured by the pyrometer.

21. The method of any of claims 20 and 22-23, wherein modifying the delivery of radiation comprises changing the intensity of the radiation.

22. The method of any of claims 20-21 and 23, wherein modifying the delivery of radiation comprises changing the location of the radiation.

23. The method of any of claims 20-22, wherein modifying the delivery of radiation comprises changing the duration of application of the radiation.
